(19) United States
(12) Patent Application Publication
(10) Pub. No.: US 2024/0244044 A1
(43) Pub. Date: Jul. 18, 2024

(54) SYSTEM FOR CONTROLLING NETWORK CONNECTION BASED ON CONTROLLER, AND METHOD FOR SAME

(71) Applicant: PRIBIT Technology, Inc., Seoul (KR)

(72) Inventor: Young Rang KIM, Seoul (KR)

(21) Appl. No.: 18/559,519

(22) PCT Filed: Apr. 27, 2022
(86) PCT No.: PCT/KR2022/006022

§ 371 Date: Nov. 7, 2023

(30) Foreign Application Priority Data
May 7, 2021 (KR) 10-2021-0059271

(51) Int. Cl. H04L 9/40

(52) U.S. Cl. CPC H04L 63/08; H04L 63/029

(57) ABSTRACT

A node includes a communication circuit, a processor operatively connected to the communication circuit, and a memory operatively connected to the processor and storing a reception application and an access control application, and the memory stores instructions that, when executed by the processor, cause the node to detect an event of a network reception from a source network of the reception application through the access control application, to determine whether a data flow, which corresponds to identification information of the reception application, a service port, and the source network and is authorized from an external server exists, through the access control application, to receive a data packet using the communication circuit, when the authorized data flow exists and the reception application is attempting to receive, and to drop the data packet when the authorized data flow information does not exist or the reception application is not attempting to receive.

### CROSS REFERENCES

The application is a U.S. National Stage Application of International Application No. PCT/KR2022/006022, filed Apr. 27, 2022, which claims the benefit of priority based on Korean Patent Application No. 10-2021-0059271, filed on May 7, 2021, the disclosures of each of which are hereby expressly incorporated by reference herein in their entireties.

### TECHNICAL FIELD

The present disclosure relates to a system for controlling a controller-based network access and a method therefor.

### BACKGROUND

Multiple devices may communicate data over a network. For example, a smartphone may transmit or receive data to and from a server via the Internet. The network may include a private network such as an intranet as well as a public network such as the Internet.

To control indiscriminate access with respect to a network, a technology for limiting access to the network is being applied based on a transmission control protocol (TCP)/internet protocol (IP).

For example, a NAC (network access controller) allows an authorized terminal to access a network by receiving an authorized IP address, and has a method of blocking unauthorized terminals using an ARP (address resolution protocol) spoofing when an unauthorized terminal uses an unauthorized IP address. A firewall has a method of determining whether to allow transmission of a data packet based on source IP, destination IP, and port information included in IP header information and a policy. A virtual private network (VPN) has a method of ensuring the integrity and confidentiality of data packets by using a tunnel to which encryption is applied over the TCP/IP protocol.

However, the ARP spoofing puts a load on the network, and technologies to bypass it have recently been developed. Since the firewall is for controlling the flow of data packets, it may not be directly involved in the process of generating a connection between two nodes. Also, the VPN is vulnerable to the management of the flow of data packets after the tunnel is generated. In addition, since the above technologies are based on the TCP/IP, security of another layer (e.g., an application layer) among open system interconnection (OSI) layers may be vulnerable.

Various embodiments disclosed in this document are intended to provide a system for solving the above-described problems in a network environment and a method therefor.

### SUMMARY

According to an embodiment of the present disclosure, a node includes a communication circuit, a processor operatively connected to the communication circuit, and a memory operatively connected to the processor and that stores a reception application and an access control application, and the memory stores instructions that, when executed by the processor, cause the node to detect an event of a network reception from a source network of the reception application through the access control application, to determine whether a data flow, which corresponds to identification information of the reception application, a service port, and the source network and is authorized from an external server exists, through the access control application, to receive a data packet using the communication circuit, when the authorized data flow exists and the reception application is attempting to receive, and to drop the data packet when the authorized data flow information does not exist or the reception application is not attempting to receive.

According to an embodiment, the instructions may cause the node to determine whether a reception is possible when a request is received from the external server to identify whether the reception application is receivable, to perform a validation inspection of the reception application and to transmit a result of the validation inspection to the external server, when the reception application is receivable.

According to an embodiment, the node may further include a display, and the instructions may cause the node to detect an event of a controller access with respect to the external server through the access control application, to request a controller access to the external server using the communication circuit in response to the detected event of the controller access, to receive a first response with respect to the request of the controller access from the external server, the first response being including identification information of a generated control flow, and to output a user interface screen indicating that an access with respect to the external server is completed or indicating that the access with respect to the external server is blocked through the display, based on the first response.

According to an embodiment, the instructions may cause the node to receive a first user input requesting a user authentication, and to request a user authentication with respect to a user of the node to the external server, and the request of the user authentication being including information corresponding to the first user input, to receive a second response with respect to the user authentication request from the external server, and to output a user interface screen indicating that the user authentication is completed or indicating that the user authentication fails through the display, based on the second response.

According to an embodiment, the instructions may cause the node to receive a second user input requesting a release of a network access, and to request the external server to release the network access in response to the second user input.

According to an embodiment, instructions may cause the node to detect an update event of a control flow generated between the node and the external server, to request an update of the control flow to the external server using the communication circuit in response to the detected event, and to receive a third response with respect to the update request of the control flow from the external server, and wherein the third response includes information on the data flow.

According to an embodiment, the instructions may cause the node to receive information indicating a deletion of the authorized data flow from the external server, and to update the authorized data flow from the external server based on the deletion information with respect to the authorized data flow.

According to an embodiment of the present disclosure, a server includes a communication circuit, a memory storing a database, and a processor operatively connected to the communication circuit and the memory, and the processor receives, from a first access control application of a source node, a first request requesting a network access with respect to a destination node of a target application stored in the source node, the first request being including identification information of a control flow, identification information of the target application, and identification information of the destination node, determines whether the target application is accessible based on the identification information of the control flow and the database, determines whether a data flow including identification information of the source node, the identification information of the destination node, and identification information of the reception application exists based on the database, when the target application is accessible, requests the destination node to determine whether the reception application and the destination node are receivable, when the data flow does not exist, generates the data flow and transfer the data flow generated using the communication circuit to the destination node when the destination node and the reception application are receivable, and transmits an inaccessible result to the source node using the communication circuit, when the destination node or the reception application is unable to receive.

According to an embodiment, the processor may determine whether an authorized tunnel exists between the target application and a gateway of the destination node, based on the database, the identification information of the target application, and the identification information of the destination node when the data flow exists or the data flow is generated, and may transmit the determined result to the first access control application using the communication circuit.

According to an embodiment, the processor may transmit identification information of the authorized tunnel using the communication circuit when the authorized tunnel exists, may generate information necessary to generate a tunnel, may update the data flow, may transmit the information necessary to generate the tunnel to the gateway, and may transmit the updated data flow to the first access control application, when the authorized tunnel does not exist, and may transmit information indicating that a network access with respect to the destination node of the target application is impossible when there is no tunnel that satisfies a policy included in the database.

According to an embodiment, the processor may receive a second request requesting a controller access with respect to the server from the access control application of a node, the second request being including identification information of at least one of the node, the access control application, or a network to which the node belongs, may determine whether the node is an accessible device based on the identification information included in the second request and the database, may generate the control flow, when the node is the accessible device, and may transmit the identification information of the generated control flow to the node using the communication circuit, and the node may include the source node and the destination node, and the access control application may include the first access control application of the source node and a second access control application of the destination node.

According to an embodiment, the processor may receive a third request requesting a user authentication with respect to a user of the node from the access control application through the control flow, the third request being including user identification information related to the user authentication, may authenticate the user of the node based on information included in the third request and the database, and may transmit a result of the user authentication to the access control application through the control flow using the communication circuit.

According to an embodiment, the processor may receive, from the first access control application, a fourth request requesting a release of the network access, may remove the control flow in response to the fourth request, may release and update the data flow dependent on the control flow, and may request the gateway to remove a tunnel dependent on the control flow and transmit the updated data flow to the destination node, using the communication circuit.

According to an embodiment, the processor may receive, from the second access control application, a fifth request requesting a release of the network access, may remove the control flow in response to the fifth request, and may release the data flow dependent on the control flow.

According to an embodiment, the processor may receive a sixth request requesting update of the control flow from the node, the sixth request being including identification information of the control flow, may update the control flow based on identification information included in the sixth request and the database, may update the data flow information, and may transmit the updated information to the node.

According to the embodiments disclosed in the present disclosure, a node may block a data packet reception of an unauthorized application.

In addition, according to the embodiments disclosed in the present disclosure, compared to network security technologies based on a wide range IP address such as the NAC, it is possible to solve the problem of policy setting and recovery and to prevent bypass attacks.

In addition, according to the embodiments disclosed in the present disclosure, since a man in the middle (MITM) attack may be blocked in a zero trust network environment, tunnel-based access control may be performed compared to the VPN that only provides section protection.

In addition, according to the embodiments disclosed in the present disclosure, it is possible to solve problems inherent in the TCP/IP-based network security technology and to provide a secure network connection.

In addition, according to the embodiments disclosed in the present disclosure, it is possible to solve the problem of setting a policy according to the network control device.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 illustrates an environment including a plurality of networks.

FIG. 2 illustrates an architecture in a network environment according to various embodiments.

FIG. 3 is a functional block diagram illustrating a database stored in a controller according to various embodiments.

FIG. 4 is a functional block diagram of a node according to various embodiments.

FIG. 5 illustrates an operation of controlling reception of a data packet according to various embodiments.

FIG. 6 illustrates a signal flow diagram for a controller access.

FIG. 7 illustrates a user interface screen for a controller access.

FIG. 8 illustrates a signal flow diagram for a user authentication according to various embodiments.

FIG. 9 illustrates a signal flow diagram for controlling a network access.

FIG. 10 illustrates a signal flow diagram for updating a control flow according to various embodiments.

FIG. 11 illustrates operation flowchart for controlling a network access at a destination node according to various embodiments.

FIG. 12 illustrates a signal flow diagram for releasing network access depending on the request of the source node.

FIG. 13 illustrates a signal flow diagram for releasing a network access depending on a request of a destination node according to various embodiments.

FIG. 14 illustrates a user interface screen for releasing a network access.

### DETAILED DESCRIPTION

Hereinafter, various embodiments of the disclosure will be described with reference to accompanying drawings. However, those of ordinary skill in the art will recognize that modification, equivalent, and/or alternative on various embodiments described herein may be variously made without departing from the scope and spirit of the disclosure.

In this specification, the singular form of a noun corresponding to an item may include one item or a plurality of items, unless the relevant context clearly dictates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that when a component (e.g., a first component) is referred to, with or without the term “functionally” or “communicatively”, as “coupled” or “connected” to another component (e.g., a second component), it means that the component may be coupled with the other component directly (e.g., wiredly), wirelessly, or via a third component.

Each component (e.g., module or program) of the components described in this specification may include singular or plural entities. According to various embodiments, one or more components or operations among corresponding components may be omitted, or one or more other components or operations may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. According to various embodiments, operations performed by modules, programs, or other components are executed sequentially, in parallel, iteratively, or heuristically, one or more of the operations are executed in a different order, omitted, or one or more other operations may be added.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in the form of an application-specific integrated circuit (ASIC).

Various embodiments of the present disclosure may be implemented as software (e.g., a program or application) including one or more instructions stored in a storage medium (e.g., a memory) readable by a machine. For example, a processor of the machine may invoke at least one command among one or more instructions stored from a storage medium and execute it. This enables the machine to be operated to perform at least one function according to the at least one instruction invoked. The one or more instructions may include code generated by a compiler or code executable by an interpreter. The machine-readable storage medium may be provided in the form of a non-transitory storage medium. Here, ‘non-transitory’ only means that the storage medium is a tangible device and does not contain a signal (e.g., electromagnetic waves), and this term does not distinguish between a case where data are semi-permanently stored in a storage medium and a case where data are temporarily stored.

Methods according to various embodiments disclosed in this document may be provided by being included in a computer program product. The computer program products may be traded between sellers and buyers as commodities. The computer program product may be distributed in the form of a machine-readable storage medium (e.g., a compact disc read only memory (CD-ROM)), or may be distributed directly or online (e.g., downloaded or uploaded) through an application store or between two user devices (e.g., smartphones). In the case of online distribution, at least a part of the computer program product may be temporarily stored or temporarily generated in a machine-readable storage medium such as a memory of a server of a manufacturer, a server of an application store, or a relay server.

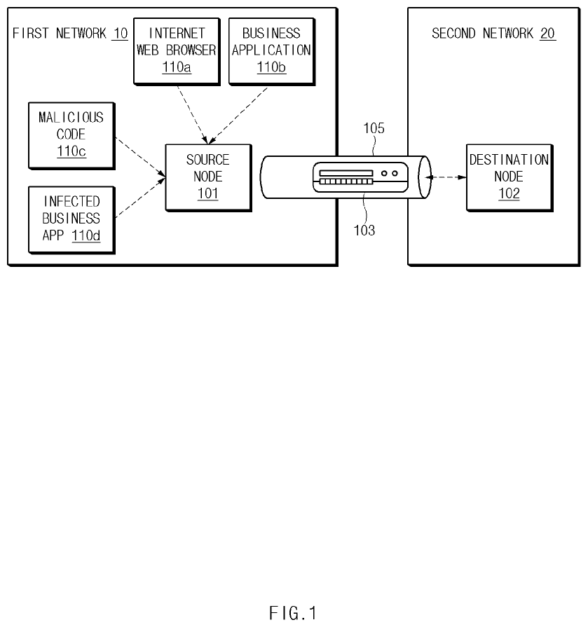

FIG. 1 illustrates an environment including a plurality of networks.

Referring to FIG. 1, a first network 10 and a second network 20 may be different networks. For example, the first network 10 may be a public network such as the Internet, and the second network 20 may be a private network such as an intranet or the VPN.

The first network 10 may include a source node 101. In FIG. 1 and the embodiments described below, the ‘source node’ may be various types of devices capable of performing data communication. For example, the source node 101 may be a portable device such as a smartphone or tablet, a computer device such as a desktop or laptop, a multimedia device, a medical device, a camera, a wearable device, a virtual reality (VR) device, or home appliances, and is not limited to the above-mentioned devices. For example, the source node 101 may include a server or gateway that may transmit data packets through an application. The source node 101 may also be referred to as an ‘electronic device’ or a ‘terminal’. Meanwhile, a destination node 102 may include the same or similar device as the above-described source node 101.

The source node 101 may attempt to access the second network 20 and may transmit data to the destination node 102 included in the second network 20. The source node 101 may transmit data to the destination node 102 through a gateway 103 and a tunnel 105.

When an access of the source node 101 with respect to the first network 10 is approved, the source node 101 may communicate with all servers included in the first network 10, so that the source node 101 may be exposed to attacks by malicious programs. For example, the source node 101 may receive data of untrusted or unsecured applications such as a malicious code 110c and an infected business application 110d, as well as data of trusted and/or secure applications such as an internet web browser 110a and a business applications 110b.

The source node 101 infected by a malicious program may attempt to access and/or to transmit data to the second network 20. When the second network 20 is formed based on IP, such as a VPN, it may be difficult for the second network 20 to individually monitor a plurality of devices included in the second network 20, and security may be vulnerable to an application layer or a transmission layer in OSI layers. In addition, when the source node 101 includes a malicious application after the tunnel is generated in advance, the data of the malicious application will be transferred to another electronic device (e.g., the destination node 102) within the second network 20.

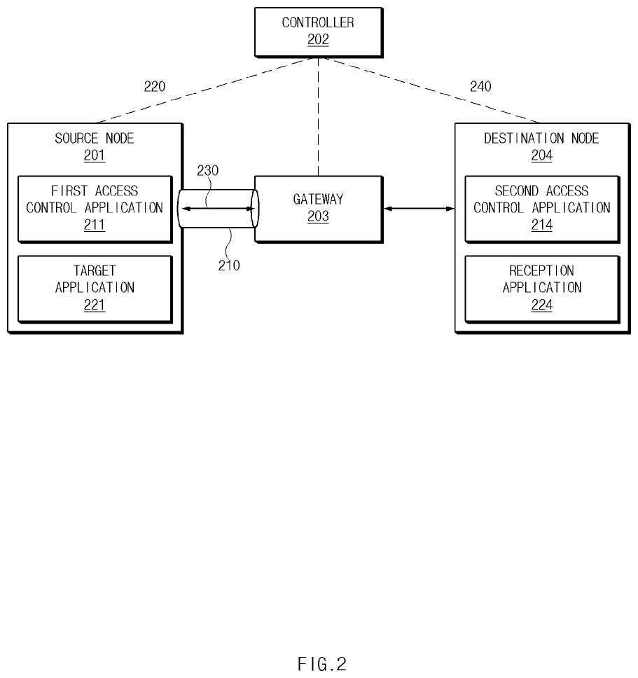

FIG. 2 illustrates an architecture in a network environment according to various embodiments.

Referring to FIG. 2, the number of a source node 201, a gateway 203, and a destination node 204 is not limited to the number illustrated in FIG. 2. For example, the source node 201 may transmit data to a plurality of destination nodes through a plurality of gateways, and a controller 202 may manage a plurality of source nodes, gateways, and destination nodes. The source node 201 may perform the same and similar functions as the source node 101 illustrated in FIG. 1, the gateway 203 may perform the same and similar functions as the gateway 103 illustrated in FIG. 1, and the destination node 204 may perform the same and similar functions as the destination node 102 illustrated in FIG. 1.

The controller 202 may be, for example, a server (or cloud server). The controller 202 may ensure reliable data transmission within a network environment by managing data transmission between the source node 201, the gateway 203, and the destination node 204. For example, the controller 202 may manage the access of the source node 201 with respect to the destination node 204 through policy information or blacklist information, may mediate the generation of an authorized tunnel 210 between the source node 201 and the gateway 203, or may remove the tunnel 210 according to security events collected from the source node 201 or the gateway 203. The source node 201 may communicate with the destination node 204 only through the tunnel 210 authorized by the controller 202, and when the authorized tunnel 210 does not exist, the source node 201 may be blocked from accessing the destination node 204. According to an embodiment, the controller 202 exchanges control data packets with the source node 201 to perform various operations (e.g., registration, approval, authentication, update, termination) associated with the network access of the source node 201. In addition, the controller 202 may transmit and receive control data packets to and from the destination node 204 in order to perform various operations (e.g., registration, approval, authentication, update, termination) associated with the network access and network reception of the destination node 204. A flow (e.g., 220 or 240) through which control data packets are transmitted may be referred to as a control flow.

Meanwhile, the controller 202 may include a server or an external server.

The gateway 203 may be located at the border of the network to which the source node 201 belongs or the border of the network to which the destination node 204 belongs. There may be multiple gateways 203. The gateway 203 may forward only data packets received through the authorized tunnel 210 among the data packets received from the source node 201 to the destination node 204. A flow (e.g., 230) in which data packets are transmitted between the source node 201 and the gateway 203, the gateway 203 and the destination node 204, or the source node 201 and the destination node 204 may be referred to as a data flow. Compared to the tunnel 210 generated on a terminal or an IP unit, the data flow may be generated in more detailed units (e.g., application). According to an embodiment, the gateway 203 may be connected to the controller 202 on a cloud basis. The gateway 203 may generate the source node 201 and the authorized tunnel 210 under the control of the controller 202.

According to various embodiments, the source node 201 may include a first access control application 211 for managing a network access of applications stored in the source node 201 and a network driver (not illustrated). For example, when an access event occurs for the destination node 204 of a target application 221 (e.g., any one of the applications 110a to 110d in FIG. 1) included in the source node 201, the first access control application 211 may determine whether the target application 221 is accessible. When the target application 221 is accessible, the first access control application 211 may transmit a data packet to the gateway 203 through the tunnel 210. The first access control application 211 may control a transmission of data packets within the source node 201 through a kernel including an operating system and a network driver.

According to various embodiments, the destination node 204 may include a second access control application 214 for managing a network access of applications stored in the destination node 204 and a network driver (not illustrated). For example, when a reception event occurs from the source node 201 of a reception application 224 included in the destination node 204, the second access control application 214 may determine whether the reception application 224 is receivable. When the reception application 224 is receivable, the second access control application 214 may receive data packet from the source node 201 or the gateway 203. The second access control application 214 may control a reception of data packets within the destination node 204 through a kernel including an operating system and a network driver.

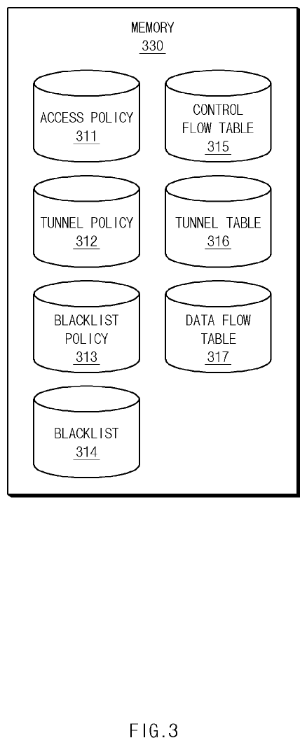

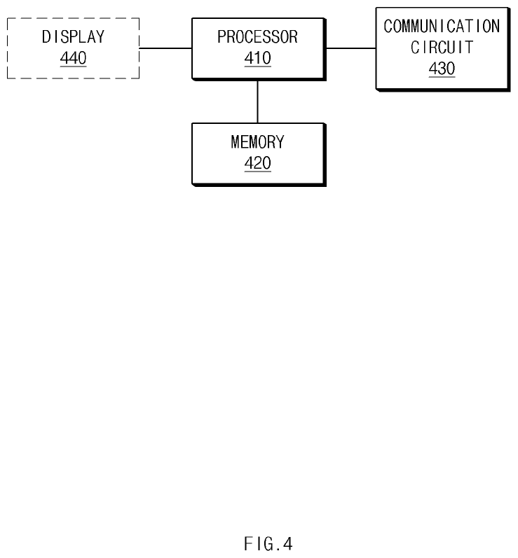

FIG. 3 is a functional block diagram illustrating a database stored in a controller (e.g., the controller 202 of FIG. 2) according to various embodiments. Although FIG. 3 illustrates only a memory 330, the controller may further include a communication circuit (a communication circuit 430 in FIG. 4) for communicating with an external electronic device (e.g., the source node 201, the gateway 203, or the destination node 204 of FIG. 2), and a processor (e.g., a processor 410 in FIG. 4) for controlling the overall operation of the controller.

Referring to FIG. 3, the controller may store databases 311 to 317 for controlling network access and data transmission in the memory 330.

The access policy database 311 may include information about networks and/or services to which an identified network, source node, destination node, user, or application are accessible. For example, when an access to a destination node is requested from a source node, the controller may determine whether the identified network (e.g., the network to which the source node belongs), the source node, the user (e.g., the user of the source node), and/or an application (e.g., the application included in the source node) are accessible to the destination node, based on the access policy database 311.

The tunnel policy database 312 may include the type, encryption method, and encryption level information of the tunnel to be connected to the gateway existing at the border of the network and the source node (e.g., the terminal) on a connection path. For example, when the access to the destination node is requested from the source node, the controller may provide the source node with the optimal tunnel for accessing the destination node and information about it based on the tunnel policy database 312.

The blacklist policy database 313 may include a policy for permanently or temporarily blocking the access to a specific node (e.g., a source node or a destination node). The blacklist policy database 313 may be generated based on information (e.g., at least one of a source node ID (identifier), an IP address, a MAC (media access control) address, or a user ID) identified through analysis of security event risk, occurrence cycle, and/or behavior among security events periodically collected from the source node, destination node, or gateway.

The blacklist database 314 may include a list of at least one of a source node, a destination node, an IP address, a MAC address, or a user blocked by the blacklist policy database 313. For example, when the identification information of the source node requesting the access to the destination node is included in the blacklist database 314, the controller may isolate the source node from the destination node by rejecting the access request of the source node.

A control flow table 315 is an example of a session table for managing a flow (e.g., the control flow) of control data packets generated between the node (e.g., the source node or the destination node) and the controller. When successfully accessing to the controller, the control flow information may be generated by the controller. The control flow information may include at least one of control flow identification information, an IP address identified when accessing to and authenticating the controller, a node ID, or a user ID. For example, when the access to a destination node is requested from a source node, the controller may retrieve the control flow information through the control flow identification information received from the source node, and may map at least one of the IP address, source node ID, or user ID included in the retrieved control flow information to the access policy database 311, thereby determining whether the access of the source node is possible and whether to generate a tunnel.

According to an embodiment, the control flow may have an expiration time. A node (e.g., a source node or a destination node) should update the expiration time of the control flow, and when the expiration time is not updated within a certain period of time, the control flow (or the control flow information) may be removed. Additionally, when it is determined that immediate access blocking is necessary according to security events collected from a node or gateway, the controller may remove the control flow according to access termination request of the node. When the control flow is removed, the tunnel generated in advance and the data flow are also removed, so the access of the node may be blocked.

A tunnel table 316 is a table for managing tunnels connected between the source node and the gateway. The tunnel may be generated in a device unit or IP unit, for example. When a tunnel is generated between a source node and a gateway, the tunnel table 316 may include tunnel identification information, control flow identification information when the tunnel is dependent on a control flow, a tunnel end point (TEP), a tunnel start point (TSP), a tunnel algorithm, a tunnel type, and/or additional information for managing a tunnel.

A data flow table 317 is a table for managing the flow (e.g., the data flow) in which detailed data packets are transmitted between the source node and the destination node. The data flow may be generated in units of a TCP session within a tunnel generated at the source node or IP unit, an application at the source node, or a more granular level. The data flow table 317 may include data flow identification information, control flow identification information when the data flow is dependent on the control flow, an application ID, a destination IP address, and/or service ports to identify whether the data packet transmitted from the source node is an authorized data packet. Additionally, the data flow table 317 may include identification information of the tunnel through which the data flow will be used. Also, the data flow table 317 may include a header (or header information) to determine whether a data packet is valid. In addition, the data flow table 317 may further include whether a data flow header, which is authentication information, is inserted into the data packet, a header insertion method, whether authentication of the data flow is required, authentication status, and/or authentication expiration time. Additionally, the data flow table 317 may include source node information (e.g., source IP) of the destination node, service port information, and receivable application information.

FIG. 4 illustrates a functional block diagram of a node (e.g., the source node 201 and the destination node 204 of FIG. 2) according to various embodiments.

Referring to FIG. 4, a node may include the processor 410, a memory 420, and the communication circuit 430. According to an embodiment, the node may further include a display 440 to interface with the user.

The processor 410 may control the overall operation of the node. In various embodiments, the processor 410 may include one processor core (single core) or may include a plurality of processor cores. For example, the processor 410 may include a multi-core such as a dual-core, a quad-core, a hexa-core, or the like. According to embodiments, the processor 410 may further include a cache memory located internally or externally. According to embodiments, the processor 410 may be configured with one or more processors. For example, the processor 410 may include at least one of an application processor, a communication processor, or a graphical processing unit (GPU).

All or a portion of processor 410 may be electrically or operatively coupled with or connected to other components (e.g., the memory 420, the communication circuit 430, or the display 440) within the node. The processor 410 may receive commands from other components of the node, may interpret the received commands, and may perform calculations or process data according to the interpreted commands. The processor 410 may interpret and process messages, data, instructions, or signals received from the memory 420, the communication circuit 430, or the display 440. The processor 410 may generate new messages, new data, new instructions, or new signals based on received messages, data, instructions, or signals. The processor 410 may provide processed or generated messages, data, instructions, or signals to the memory 420, the communication circuit 430, or the display 440.

The processor 410 may process data or signals generated or generated by a program. For example, the processor 410 may request instructions, data, or signals from the memory 420 to execute or control a program. The processor 410 may record (or store) or update instructions, data, or signals to the memory 420 in order to execute or control a program.

The memory 420 may store instructions for controlling nodes, control instruction codes, control data, or user data. For example, the memory 420 may include at least one of an application program, an operating system (OS), middleware, or a device driver.

The memory 420 may include one or more of a volatile memory or a non-volatile memory. The volatile memory may include a dynamic random access memory (DRAM), a static RAM (SRAM), a synchronous DRAM (SDRAM), a phase-change RAM (PRAM), a magnetic RAM (MRAM), a resistive RAM (RRAM), a ferroelectric RAM (FeRAM), and the like. The non-volatile memory may include a read only memory (ROM), a programmable ROM (PROM), an electrically programmable ROM (EPROM), an electrically erasable programmable ROM (EEPROM), a flash memory, and the like.

The memory 420 may further include non-volatile media such as a hard disk drive (HDD), a solid state disk (SSD), an embedded multi media card (eMMC), and universal flash storage (UFS).

According to an embodiment, the memory 420 may store some of the information included in the memory (e.g., the memory 330 in FIG. 3) of the controller. For example, the memory 420 may store the tunnel table 316 and the data flow table 317 described in FIG. 3.

The communication circuit 430 may support establishment of a wired or wireless communication connection between a node and an external electronic device (e.g., the controller 202 or gateway 203 of FIG. 2) and performing communication through the established connection. According to an embodiment, the communication circuit 430 may include a wireless communication circuit (e.g., a cellular communication circuit, a short-range wireless communication circuit, or a global navigation satellite system (GNSS) communication circuit) or a wired communication circuit (e.g., a local area network (LAN)) communication circuit, or power line communication circuit), and may communicate with external electronic devices using the corresponding communication circuit, through a short-range communication network such as Bluetooth, WiFi direct, or IrDA (infrared data association) or a long-distance communication such as a cellular network, the Internet, or a computer network. The various types of communication circuits 430 described above may be implemented as one chip or may be implemented as separate chips.

The display 440 may output content, data, or signals. In various embodiments, the display 440 may display image data processed by the processor 410. According to embodiments, the display 440 may be configured with an integrated touch screen by being combined with a plurality of touch sensors (not illustrated) capable of receiving touch input, and the like. When the display 440 is configured with the touch screen, the plurality of touch sensors may be placed above the display 440 or below the display 440.

Meanwhile, a server (e.g., the controller) according to an embodiment may include the processor 410, the memory 420, and the communication circuit 430. The processor 410, the memory 420, and the communication circuit 430 included in the server may be actually the same as the processor 410, the memory 420, and the communication circuit 430 described above.

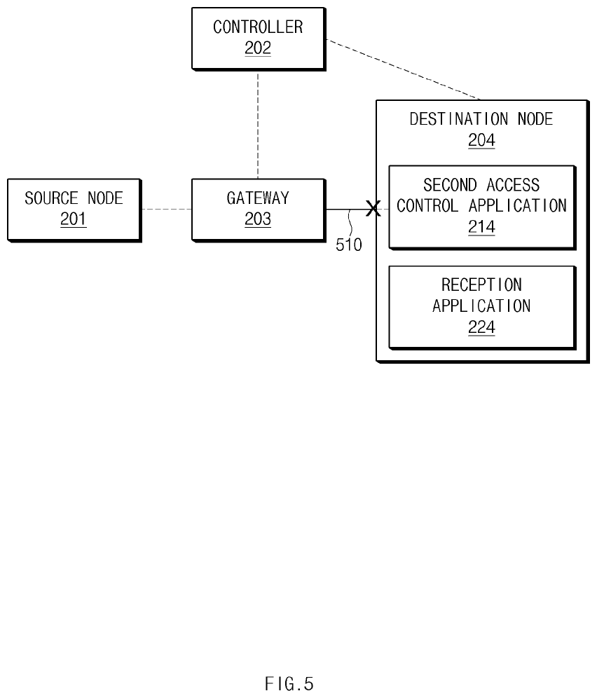

FIG. 5 illustrates an operation of controlling reception of a data packet according to various embodiments.

Referring to FIG. 5, the second access control application 214 may detect a network reception request with respect to the reception application 224 from a source network including the source node 201, and may determine whether the destination node 204 or the reception application 224 is accessed to the controller 202. When the destination node 204 or the reception application 224 is not accessed to the controller 202, the second access control application 214 may block the reception of data packets from the kernel including the operating system or the network driver (operation 510).

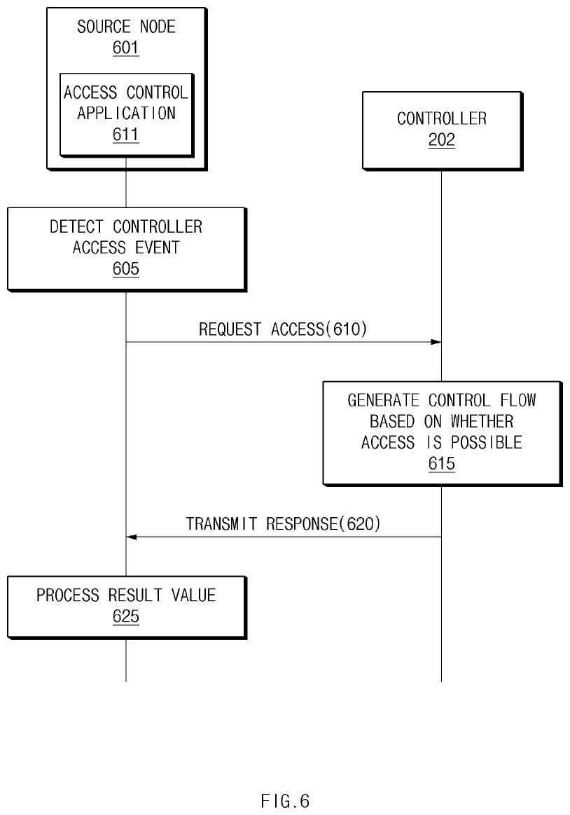

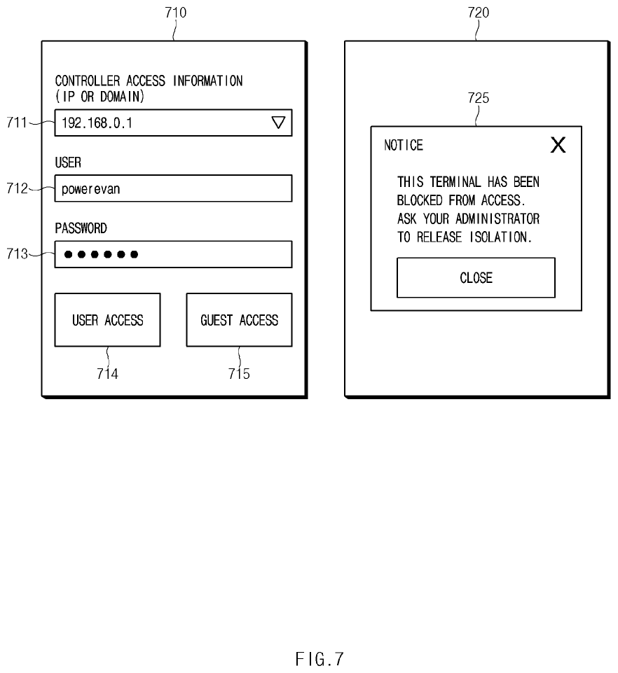

FIGS. 6 to 7 describes operations for a controller access according to various embodiments. FIG. 6 illustrates a signal flow diagram for a controller access, and FIG. 7 illustrates a user interface screen for a controller access.

Since a node 601 needs to be authorized by the controller 202 to access or receive the network, as an access control application 611 of the node 601 requests the controller 202 to generate a control flow, the node 601 may attempt to access the controller. In this case, the node 601 may include the source node 201 and the destination node 204 in FIG. 2. In addition, the access control application 611 may include the first access control application 211 and the second access control application 214 in FIG. 2.

Referring to FIG. 6, in operation 605, the node 601 may detect a controller access event. For example, the access control application 611 is installed and executed within the node 601, and the node 601 may detect that an access to the controller 202 is requested through the access control application 611.

For example, referring to FIG. 7, when the access control application 611 is executed, the node 601 may display a user interface screen 710 for receiving information necessary for the controller access. The user interface screen 710 may include an input window 711 for entering the IP or domain of the controller 202, an input window 712 for entering a user ID, and/or an input window 713 for entering a password. After information about the input windows 711 to 713 is input, the node 601 may detect the controller access event by receiving a button 714 for a controller access by an authenticated user. For another example, when user authentication of the node 601 is not yet completed, the node 601 may detect the controller access event by receiving a button 715 for a controller access by an unauthorized user (i.e., a guest).

In operation 610, the node 601 may request the controller access to the controller 202 in response to detecting the controller access event. The node 601 may request the controller access through the access control application 611. According to an embodiment, the access control application 611 may transmit identification information (e.g., a terminal ID, an IP address, and a MAC address) of the node 601, identification information of type, location, environment, and network to which the node 601 belongs, and/or identification information of the access control application 611 to the controller 202.

In operation 615, the controller 202 may identify whether the node 601 is accessible in response to the received request. According to an embodiment, the controller 202 may identify whether node 601 is accessible based on a database included in the memory (e.g., the memory 330 in FIG. 3) of the controller 202. For example, the controller 202 may determine whether the node 601 is accessible based on whether information received from the access control application 611 is included in the access policy database, and whether the identification information of the node 601 and/or the network to which the node 601 belongs is included in the blacklist database.

When the node 601 is accessible, the controller 202 may generate a control flow between the node 601 and the controller 202. In this case, the controller 202 may generate the control flow identification information in the form of random numbers and may store the identification information of the node 601 and/or the network to which the node 601 belongs in the control flow table. Information (e.g., the control flow identification information and/or the control flow information) stored in the control flow table may be used for user authentication of the node 601, information update of the node 601, policy verification for network access of the node 601, and/or validation inspection.

When the control flow is generated, in operation 620, the controller 202 may transmit a response to the controller access request to the node 601. In this case, the controller 202 may transmit the generated control flow identification information to the node 601.

In operation 625, the node 601 may process a result value according to the received response. For example, the access control application 611 may store the received control flow identification information and may display a user interface screen indicating that the controller access is complete to the user. When the controller access is completed, the network access request for the target network of the node 601 or the network reception request from the source network of the node 601 may be controlled by the controller 202.

According to another embodiment, the controller 202 may determine that the node 601 is inaccessible. For example, when the identification information of the node 601 and/or the network to which the node 601 belongs is included in the blacklist database, the controller 202 may determine that the node 601 is inaccessible. In this case, in operation 615, the controller 202 may not generate the control flow, and in operation 620, may transmit a response indicating that the node 601 is inaccessible to access to the controller.

The response indicating that access of the node 601 is impossible is received, in operation 625, the node 601 may output the user interface screen indicating that access to the controller is not possible to the user. For example, referring to FIG. 7, the node 601 may display a user interface screen 720 through the access control application 611. The user interface screen 720 may indicate that access of node 601 is blocked and may include a user interface 725 that guides the release of isolation by an administrator (e.g., the controller 202).

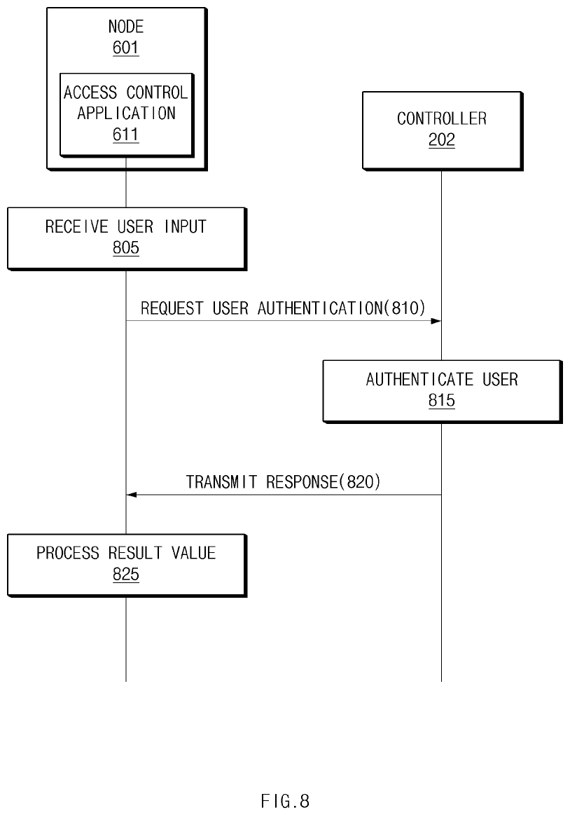

FIG. 8 illustrates a signal flow diagram for a user authentication according to various embodiments.

In order for the node 601 (e.g., the source node 201 or the destination node 204 in FIG. 2) to be granted detailed access rights to the target network, the access control application 611 (e.g., the first access control application 211 or the second access control application 214 in FIG. 2) of the node 601 may receive authentication for the user of the node 601 from the controller 202.

Referring to FIG. 8, in operation 805, the node 601 may receive an input for user authentication. The input for user authentication may be, for example, a user input of entering a user ID and password. For another example, the input for user authentication may be a user input for enhanced authentication (e.g., biometric information).

In operation 810, the node 601 may request user authentication to the controller 202. For example, the access control application 611 may transmit input information for user authentication to the controller 202. When a control flow between node 601 and the controller 202 is already generated, the access control application 611 may transmit input information for user authentication along with control flow identification information.

In operation 815, the controller 202 may authenticate the user based on information received from the node 601. For example, the controller 202 may determine whether the user is accessible according to the access policy and whether the user is included in the blacklist, based on the user ID, the password, and/or enhanced authentication information included in the received information and the database (e.g., the access policy database 311 or the blacklist database 314 of FIG. 3) included in the memory of the controller 202.

When the user is authenticated, the controller 202 may add the user's identification information (e.g., user ID) to the identification information of the control flow. The added user identification information may be used to a controller access or a network access of the authenticated user.

In operation 820, the controller 202 may transmit information indicating that the user is authenticated to the node 601 in response to the user authentication request.

In operation 825, the node 601 may process a result value of user authentication. For example, the node 601 may output a user interface screen indicating that user authentication is complete to the user through a display.

According to another embodiment, the controller 202 may determine that user authentication is not possible. For example, when the identification information of the user is included in the blacklist database, the controller 202 may determine that user authentication is not possible. In this case, in operation 820, the controller 202 may transmit information indicating that user authentication is impossible to the node 601, and in operation 825, the node 601 may output a user interface screen indicating that user authentication fails through a display.

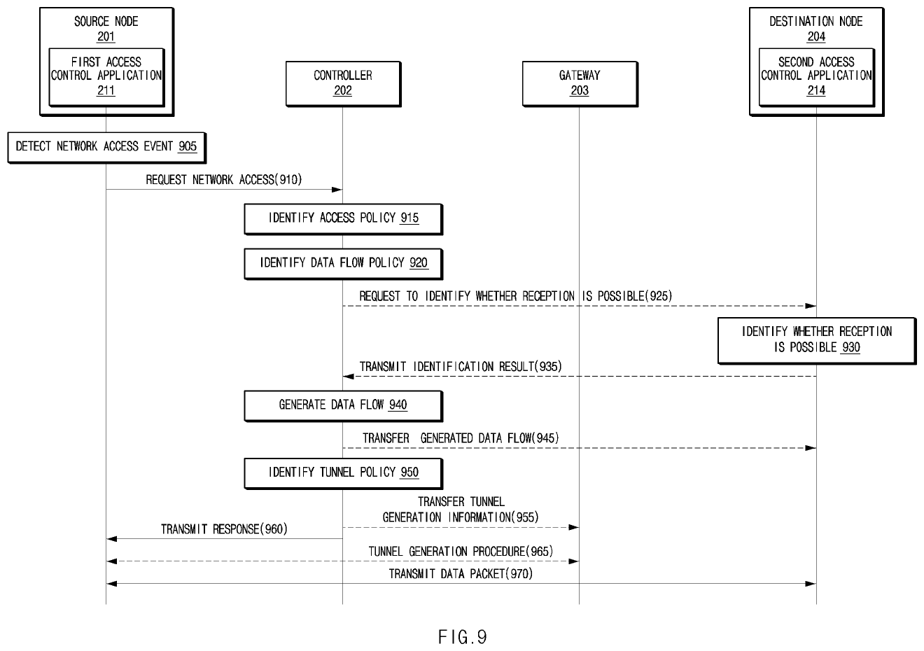

FIG. 9 illustrates an operation for controlling a network access according to various embodiments. FIG. 9 illustrates a signal flow diagram for controlling a network access.

After the source node 201 is authorized by the controller 202, the source node 201 may ensure trusted data transmission by controlling the network access of other applications stored in the source node 201 through the first access control application 211 of the source node 201.

Referring to FIG. 9, in operation 905, the first access control application 211 may detect a network access event. For example, the first access control application 211 may detect that a target application, such as a web browser, attempts to access to a target network that includes the destination node 204, such as the Internet. For example, the user may run a web browser and enter and invoke the web address to be accessed.

In operation 910, the first access control application 211 may request the network access of the target application to the controller 202. In this case, the first access control application 211 may transmit identification information of the target application and identification information (e.g., IP of the destination node and service port information) of the destination node 204 together with identification information of the control flow generated between the source node 201 and the controller 202 to the controller 202.

In operation 915, the controller 202 may identify an access policy based on the request received from the first access control application 211 and the database of the controller 202. For example, the controller 202 may determine whether the target application is accessible based on whether information received from the first access control application 211 satisfies the access policy included in the database of the controller 202. When an access to the target application is not possible, in operation 960, the controller 202 may transmit information indicating that the access is not possible to the source node 201. In this case, the first access control application 211 may drop the data packet of the target application and may output a user interface screen indicating that the access to the network is impossible through the display.

When the access of the target application is possible, in operation 920, the controller 202 may determine whether the data flow including the database included in the controller 202, identification information (e.g., IP of the source node) of the source node 201, identification information (e.g., IP of the destination node, service port information) of the destination node 204, and identification information of the reception application of the destination node 204 exists. For example, the controller 202 may perform operation 940 when the data flow exists. As another example, when the data flow does not exist, the controller 202 may perform operation 925.

When the data flow does not exist, in operation 925, the controller 202 may request the destination node 204 to identify whether the reception application and the destination node 204 are receivable. For example, the controller 202 may request the destination node 204 to identify whether the reception application may receive a data packet through a designated service port. Operation 925 may not be performed when the data flow exists in operation 920.

In operation 930, when a request from the controller 202 to identify whether the reception application may receive data packets through the designated service port is received, the second access control application 214 of the destination node 204 may determine whether reception is possible based on the received reception application information and the service port information. For example, when the reception application requested from the controller 202 is in a state capable of receiving data packets through the designated service port, the second access control application 214 may perform a validation inspection according to the validation inspection policy. In this case, the validation inspection may be performed to determine the integrity and stability of the application, and may include at least one of an inspection whether the application is forged or altered, a code signing inspection, and a fingerprint inspection. Meanwhile, operation 930 may not be performed when the data flow exists in operation 920.

In operation 935, the second access control application 214 of the destination node 204 may transmit to the controller 202 whether the reception application is capable of receiving data packets through the designated service port and the result of the validation inspection. Meanwhile, operation 935 may not be performed when the data flow exists in operation 920.

In operation 940, the controller 202 may generate a data flow based on a result identified from the second access control application 214. For example, the controller 202 may generate the data flow when the reception application is capable of receiving data packets through the designated service port.

For another example, when it is impossible for the reception application to receive a data packet through the designated service port, or when the validation inspection result is failure, in operation 960, the controller 202 may notify the source node 201 that network access is impossible using the communication circuit. In this case, the first access control application 211 may drop the data packet of the target application and may display a user interface screen indicating that network connection is impossible.

In operation 945, the controller 202 may transfer the generated data flow to the destination node 204. For example, the second access control application 214 of the destination node 204 may receive the generated data flow and may update the existing data flow table. Meanwhile, operation 945 may not be performed when the data flow is not generated in operation 940.

When the data flow exists in operation 920 or when the data flow is generated in operation 940, in operation 950, the controller 202 may determine whether an authorized tunnel exists between the target application and the gateway 203 of the destination node 204. For example, the controller 202 may identify a tunnel end point (TEP) and/or tunnel type in the tunnel policy corresponding to the destination node 204, and may determine whether an authorized tunnel corresponding to the identified TEP exists in the tunnel table. When the authorized tunnel exists, the controller 202 may generate the tunnel ID of the previously generated tunnel and information included in the data flow table, and in operation 960, may transmit the generated information to the source node 201. When an authorized tunnel does not exist, the controller 202 may update information (e.g., tunnel types, methods, authentication information, and/or IP and port of the TEP) required to generate the tunnel and the data flow, and may transmit the generated information to the gateway 203 and the source node 201 (operations 955 and 960).

For another example, when the tunnel that satisfies the tunnel policy among the tunnels to be generated between the source node 201 and the gateway 203 does not exist, in operation 960, the controller 202 may notify the source node 201 that the network access is not possible. In this case, the first access control application 211 may drop the data packet of the target application and may display a user interface screen indicating that network access is impossible.

In operation 960, the first access control application 211 may process the result value according to the response transmitted from the controller 202. According to an embodiment, when information indicating that the network access of the target application is impossible or that the authorized tunnel does not exist is received from the controller 202, the first access control application 211 may drop the data packet and may output the user interface screen indicating that the network access is impossible.

According to another embodiment, when information necessary for the tunnel generation is received from the controller 202, the first access control application 211 may generate a tunnel with the gateway 203 in operation 965 and may transmit the data packet of the target application through the tunnel generated in operation 970.

According to another embodiment, when a tunnel ID of an existing tunnel is received from the controller 202, in operation 970, the first access control application 211 may transmit the data packet of the target application to the destination node 204 through the tunnel corresponding to the tunnel ID, without performing an additional tunnel generation procedure.

According to another embodiment, when the tunnel generation fails, the first access control application 211 may drop the data packet of the target application and may output a user interface screen indicating that network access is impossible.

According to an embodiment, before performing operation 910, the first access control application 211 may first determine whether an authorized data flow exists from the controller 202 between the target application and the destination node 204. For example, the first access control application 211 may identify identification information of the target application, identification information (e.g., the destination IP) of the destination node 204, and the service port information, and may determine whether the authorized data flow corresponding to the identified information exists in the data flow table stored in the memory of the source node 201. When the authorized data flow exists, the first access control application 211 may transmit the data packet of the target application according to the authorized data flow policy in operation 970 without requesting the network access. When the authorized data flow does not exist, the first access control application 211 may request the network access in operation 910. Meanwhile, when the authorized data flow exists but is not valid (e.g., when a tunnel does not exist or when access to the destination node 204 is not possible), the first access control application 211 may drop the data packet of the target application.

According to an embodiment, the first access control application 211 may further perform validation inspection of the target application before requesting the network access to ensure the integrity and stability of the target application. For example, the first access control application 211 may perform inspection of whether the target application is forged or altered, a code signing inspection, and/or a fingerprint inspection. For another example, the first access control application 211 may determine whether the target application, access target IP, and service port are accessible based on the access policy database received from the controller 202. When the validation inspection of the target application fails, the first access control application 211 may drop the data packet of the target application without requesting the network access. In this case, the first access control application 211 may display a user interface screen indicating that access is impossible. When the validation inspection of the target application is successful, in operation 910, the first access control application 211 may request the network access.

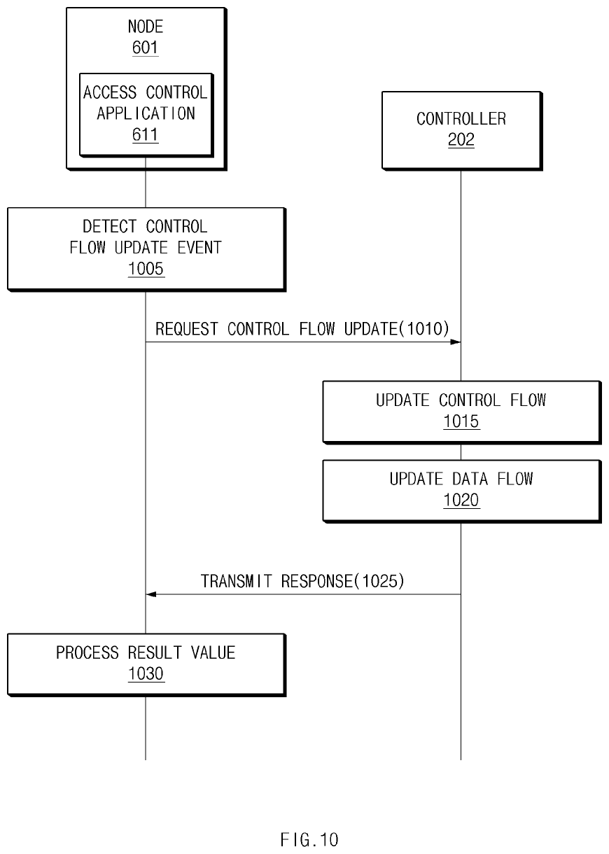

FIG. 10 illustrates a signal flow diagram for updating a control flow according to various embodiments.

The node 601 (e.g., the source node 201 and the destination node 204 in FIG. 2) may receive changed data flow information from the controller 202 by updating the control flow at designated intervals.

Referring to FIG. 10, in operation 1005, the node 601 may detect the control flow update event. For example, the access control application 611 (e.g., the first access control application 211 and the second access control application 214 in FIG. 2) may detect the control flow update event at a designated intervals.

In operation 1010, the node 601 may request the controller 202 to update the control flow. The requested information may include identification information of the control flow between the node 601 and the controller 202.

In operation 1015, the controller 202 may identify whether the node 601 is accessible through a method similar to operation 615 of FIG. 6 and may update the control flow based on the identified result. Meanwhile, when the control flow identified based on the control flow identification information is invalid, the controller 202 may transmit control flow update failure information to the node 601 through operation 1025.

When the control flow is updated, in operation 1020, the controller 202 may update the data flow that lists accessible applications and identification information of access targets by identifying the access policy that matches the identified information (e.g., identification information of the node 601, a user, or the network to which the node 601 belongs). For example, the controller 202 may update a data flow dependent on the control flow.

In operation 1025, the controller 202 may transmit a response with respect to the control flow update request to the node 601. For example, the controller 202 may transmit the control flow identification information and updated data flow table information to the node 601.

In operation 1030, the node 601 may process a result value according to the received response. For example, based on the updated data flow status information, the node 601 may update the stored data flow table. For another example, the node 601 may terminate the access control application 611 when the control flow update failure information is received.

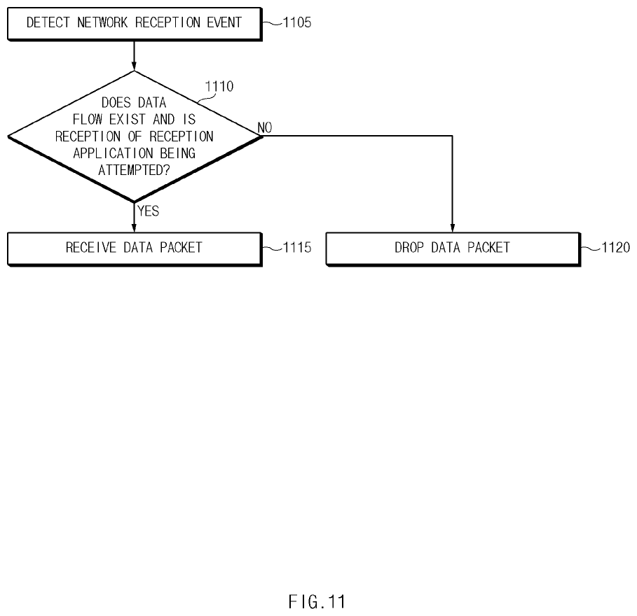

FIG. 11 illustrates an operation flowchart for controlling a network reception at a destination node according to various embodiments. Operations described below may be performed through the destination node 204 of FIG. 2. For example, the destination node may perform operations of FIG. 11 by executing instructions stored in the memory through a processor. Instructions stored in the memory may be software or programs such as the second access control application 214 of FIG. 2.

Referring to FIG. 11, in operation 1105, the second access control application 214 of the destination node 204 may detect a network reception event. For example, the second access control application 214 may detect a reception request of the data packet with respect to the reception application from the source network including the source node 201.

In operation 1110, the second access control application 214 of the destination node 204 may determine whether the data flow that corresponds to the identification information of the reception application, the service port, and the identification information of the source network and is authorized by the controller 202 exists. For example, the second access control application 214 may determine whether the authorized data flow including the source IP, service port information, and identification information of the reception application exists in the data flow table stored in the destination node 204.

When the authorized data flow exists, the second access control application 214 may determine whether the reception application is attempting reception. For example, the second access control application 214 may determine whether the reception application is in a state capable of receiving data packets through a designated service port.

When the authorized data flow exists and the reception application is attempting reception, in operation 1115, the destination node 204 may receive the data packet using the communication circuit.

In another example, when the authorized data flow does not exist or the reception application is not attempting reception, in operation 1120, the destination node 204 may drop the data packet.

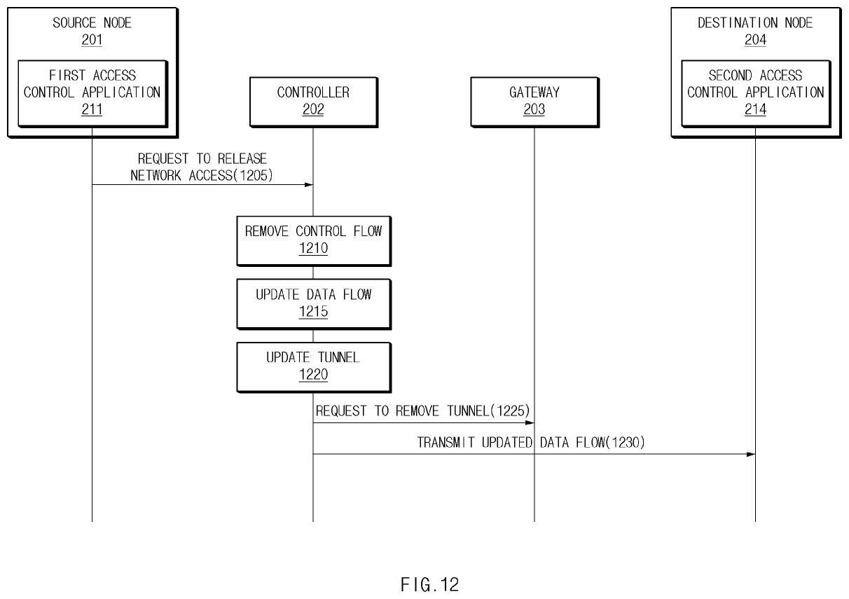

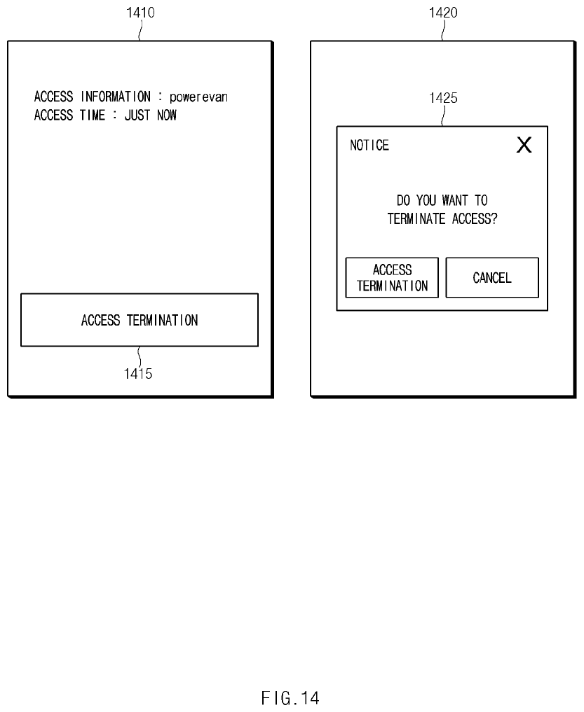

FIGS. 12 and 14 describe operations for releasing the network access according to various embodiments. FIG. 12 indicates a signal flow diagram for releasing a network access according to a request from a source node, and FIG. 14 indicates a user interface screen for releasing a network access.

Referring to FIG. 12, in operation 1205, the source node 201 may request the controller 202 to release a network access. For example, the source node 201 may transmit identification information of the control flow between the source node 201 and the controller 202 to the controller 202 along with information requesting a network access release.

According to an embodiment, the source node 201 may attempt to release the network access in response to the network access release event, such as a user request, a restart of the source node 201, or a request from the first access control application 211. For example, referring to FIG. 14, the source node 201 may receive a user input for selecting an access termination button 1415 on a user interface screen 1410 output through a display. The source node 201 may identify an access termination to the user again by outputting a user interface screen 1420 including a pop-up window 1425. For another example, the source node 201 may immediately perform operation 1205 without outputting the user interface screen 1420.

In operation 1210, the controller 202 may remove (or release) the control flow corresponding to the received identification information in response to a request from the source node 201.

In operation 1215, the controller 202 may update (or release, remove) a data flow dependent on the removed control flow. For example, there may be multiple data flow dependent on the removed control flow. In this case, the controller 202 may update (or release, remove) all data flows dependent on the removed control flow.

In operation 1220, the controller 202 may update (or release, remove) a tunnel dependent on the removed control flow. For example, there may be multiple tunnels dependent on the removed control flow. In this case, the controller 202 may update (or release, remove) all tunnels dependent on the removed control flow.

In operation 1225, the controller 202 may request the gateway 203 to remove the tunnel dependent on the removed control flow. The gateway 203 may remove the tunnel in response to the request from the controller 202.

In operation 1230, the controller 202 may transmit the updated data flow to the destination node 204. The destination node 204 may receive information about the updated data flow and may update the stored data flow table. When the data flow is removed, the data packet transmitted to the target network, including the destination node 204, corresponding to the removed data flow may be blocked by the second access control application 214. Through the above-described operations, a system including the destination node 204 may provide complete blocking and isolation in which data packets transmitted from the node 201 may no longer be received.

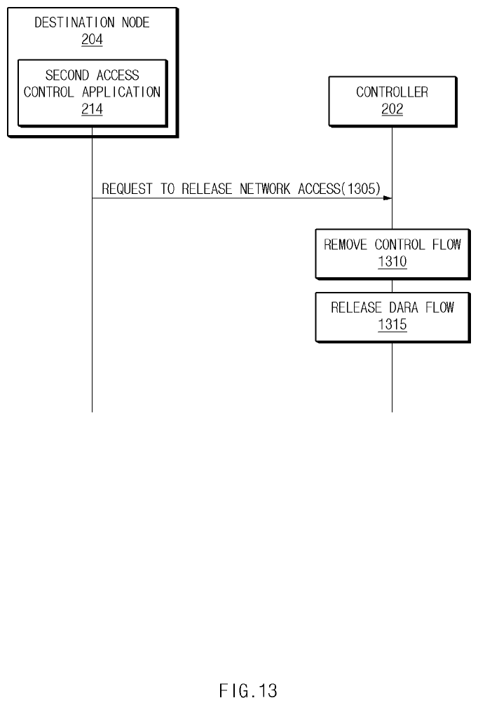

FIG. 13 illustrates a signal flow diagram for releasing a network access depending on a request of a destination node according to various embodiments.

Referring to FIG. 13, in operation 1305, the destination node 204 may request the controller 202 to release a network access. For example, the destination node 204 may transmit identification information of the control flow between the destination node 204 and the controller 202 to the controller 202 along with information requesting a network access release.

According to an embodiment, the destination node 204 may attempt to release the network access in response to the network access release event, such as a user request, a restart of the source node 204, or a request from the second access control application 214. For example, referring to FIG. 14, the destination node 204 may receive a user input for selecting the access termination button 1415 on the user interface screen 1410 output through a display. The destination node 204 may identify an access termination to the user again by outputting the user interface screen 1420 including the pop-up window 1425. For another example, the destination node 204 may immediately perform operation 1305 without outputting the user interface screen 1420.

In operation 1310, the controller 202 may remove (or release) the control flow corresponding to the received identification information in response to a request from the destination node 204.

In operation 1315, the controller 202 may release (or update, remove) a data flow dependent on the removed control flow. For example, there may be multiple data flow dependent on the removed control flow. In this case, the controller 202 may release (or update, remove) all data flows dependent on the removed control flow. Accordingly, as the data flow is released, the source node 201 may no longer transmit data packets to the destination node 204.

The above description is merely illustrative of the technical idea of the present disclosure, and those of ordinary skill in the art to which the present disclosure pertains will be able to make various modifications and variations without departing from the essential characteristics of the present disclosure.

Therefore, embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

1. A node comprising:
a communication circuit;
a processor operatively connected to the communication circuit; and
a memory operatively connected to the processor and configured to store a reception application and an access control application, and wherein the memory stores instructions that, when executed by the processor, cause the node to:
detect an event of a network reception from a source network of the reception application through the access control application;
determine whether a data flow, which corresponds to identification information of the reception application, a service port, and the source network and is authorized from an external server exists, through the access control application;
receive a data packet using the communication circuit, when the authorized data flow exists and the reception application is attempting to receive; and
drop the data packet when the authorized data flow information does not exist or the reception application is not attempting to receive.

2. The node of claim 1, wherein the instructions cause the node to:
determine whether a reception is possible when a request is received from the external server to identify whether the reception application is receivable;
perform a validation inspection of the reception application and transmit a result of the validation inspection to the external server when the reception application is receivable.

3. The node of claim 1, further comprising a display, and wherein the instructions cause the node to:
detect an event of a controller access with respect to the external server through the access control application;
request a controller access to the external server using the communication circuit in response to the detected event of the controller access;
receive a first response with respect to the request of the controller access from the external server;
the first response being including identification information of a generated control flow, and
output a user interface screen indicating that an access with respect to the external server is completed or indicating that the access with respect to the external server is blocked through the display, based on the first response.

4. The node of claim 3, wherein the instructions cause the node to:
receive a first user input requesting a user authentication;
request a user authentication with respect to a user of the node to the external server, and the request of the user authentication being including information corresponding to the first user input;
receive a second response with respect to the user authentication request from the external server; and
output a user interface screen indicating that the user authentication is completed or indicating that the user authentication fails through the display, based on the second response.

5. The node of claim 1, wherein the instructions cause the node to:
receive a second user input requesting a release of a network access; and
request the external server to release the network access in response to the second user input.

6. The node of claim 1, wherein the instructions cause the node to:
detect an update event of a control flow generated between the node and the external server;
request an update of the control flow to the external server using the communication circuit in response to the detected event; and
receive a third response with respect to the update request of the control flow from the external server, and
wherein the third response includes information on the data flow.

7. The node of claim 1, wherein the instructions cause the node to:
receive information indicating a deletion of the authorized data flow from the external server; and
update the authorized data flow from the external server based on the deletion information with respect to the authorized data flow.

8. A server comprising:
a communication circuit;
a memory storing a database; and
a processor operatively connected to the communication circuit and the memory, and wherein the processor is configured to:
receive, from a first access control application of a source node, a first request requesting a network access with respect to a destination node of a target application stored in the source node, the first request being including identification information of a control flow, identification information of the target application, and identification information of the destination node;
determine whether the target application is accessible based on the identification information of the control flow and the database;
determine whether a data flow including identification information of the source node, the identification information of the destination node, and identification information of the reception application exists based on the database, when the target application is accessible;
request the destination node to determine whether the reception application and the destination node are receivable, when the data flow does not exist;
generate the data flow and transfer the data flow generated using the communication circuit to the destination node when the destination node and the reception application are receivable; and
transmit an inaccessible result to the source node using the communication circuit when the destination node or the reception application is unable to receive.

9. The server of claim 8, wherein the processor is configured to:
determine whether an authorized tunnel exists between the target application and a gateway of the destination node, based on the database, the identification information of the target application, and the identification information of the destination node when the data flow exists or the data flow is generated; and
transmit the determined result to the first access control application using the communication circuit.

10. The server of claim 9, wherein the processor is configured to:
transmit identification information of the authorized tunnel using the communication circuit when the authorized tunnel exists;
generate information necessary to generate a tunnel, update the data flow, transmit the information necessary to generate the tunnel to the gateway, and transmit the updated data flow to the first access control application, when the authorized tunnel does not exist; and
transmit information indicating that a network access with respect to the destination node of the target application is impossible when there is no tunnel that satisfies a policy included in the database.

11. The server of claim 8, wherein the processor is configured to:
receive a second request requesting a controller access with respect to the server from the access control application of a node, the second request being including identification information of at least one of the node, the access control application, or a network to which the node belongs;
determine whether the node is an accessible device based on the identification information included in the second request and the database;
generate the control flow when the node is the accessible device; and
transmit the identification information of the generated control flow to the node using the communication circuit, and
wherein the node includes the source node and the destination node, and the access control application includes the first access control application of the source node and a second access control application of the destination node.

12. The server of claim 11, wherein the processor is configured to:
receive a third request requesting a user authentication with respect to a user of the node from the access control application through the control flow, the third request being including user identification information related to the user authentication;
authenticate the user of the node based on information included in the third request and the database; and
transmit a result of the user authentication to the access control application through the control flow using the communication circuit.

13. The server of claim 11, wherein the processor is configured to:
receive, from the first access control application, a fourth request requesting a release of the network access;
remove the control flow in response to the fourth request;
release and update the data flow dependent on the control flow; and
request the gateway to remove a tunnel dependent on the control flow and transmit the updated data flow to the destination node, using the communication circuit.

14. The server of claim 11, wherein the processor is configured to:
receive, from the second access control application, a fifth request requesting a release of the network access;
remove the control flow in response to the fifth request; and
release the data flow dependent on the control flow.

15. The server of claim 11, wherein the processor is configured to:
receive a sixth request requesting update of the control flow from the node, the sixth request being including identification information of the control flow;
update the control flow based on identification information included in the sixth request and the database;
update the data flow information; and
transmit the updated information to the node.
